(19) United States
(12) Patent Application Publication
(10) Pub. No.: US 2005/0176846 A1
(43) Pub. Date: Aug. 11, 2005

(54) Ink composition, process for producing the same, method of forming image therewith and image forming device

(76) Inventors: Koichi Sato, Kanagawa (JP); Rie Ueno, Kanagawa (JP); Ikuo Nakazawa, Kanagawa (JP); Sakae Suda, Kanagawa (JP); Masayuki Ikegami, Kanagawa (JP); Keiichiro Tsubaki, Kanagawa (JP)

Correspondence Address: MORGAN & FINNEGAN, L.L.P., 3 WORLD FINANCIAL CENTER, NEW YORK, NY, 10281-2101, US

(21) Appl. No.: 10/517,560

(22) PCT Filed: Mar. 5, 2003
(86) PCT No.: PCT/JP03/02543

(30) Foreign Application Priority Data
Jun. 11, 2002 (JP) 2002-169821

(51) Int. Cl. C03C 17/00; C09D 11/00

(52) U.S. Cl. 523/160; 523/161

(57) ABSTRACT

An ink composition contains particles having a solid coloring material substantially enclosed by a block polymer, and a solvent. The solid coloring material is enclosed in a micelle formed of the block polymer, and preferably 90 wt % or more of the solid coloring material are enclosed by the block polymer. The average particle size of the particles is 200 nm or less. A method for producing an ink composition includes forming the particles by insolubilizing the coloring material and the block polymer in a state of both being dissolved in a solution. The above described ink composition has an adequate dispersibility of the coloring material and is suitable for an ink composition for an ink-jet device.

### TECHNICAL FIELD

The present invention relates to an ink composition containing a polymer which can be used as a variety of functional materials, a production method therefor, and an image-forming method and an image-forming device using it. The present invention particularly relates to the ink composition comprising an aqueous dispersive material useful for an image-forming material preferably usable for a printer, a display and the like, and the image-forming method and the image-forming device using the ink composition.

### BACKGROUND ART

An aqueous dispersive material containing a granular solid has been conventionally and widely used for agricultural chemicals such as a herbicide and an insecticide, and medicines such as an anticancer drug, an antiallergic agent and an anti-inflammatory agent, as a functional material. In addition, a coloring material such as ink and toner, which contains a coloring agent of a granular solid, is well known. In recent years, a digital printing technology has been progressing by leaps and bounds. The digital printing technology, which is represented by an electrophotographic technology and an ink-jet technology, has been increasing its presence as an imaging technology in offices and homes in recent years.

Among them, an ink-jet technology is a direct recording method, and has striking characteristics of compactness and low power consumption. In addition, the picture quality has been rapidly improved owing to a refined nozzle. One example of the ink-jet technologies is a process of evaporating and foaming an ink supplied from an ink tank by heating it with a heater in a nozzle, and discharging the ink to form an image on a recording medium. Another example is a method of discharging the ink from the nozzle by vibrating a piezoelectric element.

Because the ink used for these methods is usually an aqueous dye solution, it might have caused blurring or a phenomenon called feathering along a fiber direction of paper at recorded portions on a recording medium, when colors have been superposed. It has been investigated to use a pigment-dispersed ink for the purpose of improving the phenomena. For instance, a method is proposed which disperses pigment with an ionic block polymer having each one or more components of a hydrophilic component and a hydrophobic component (U.S. Pat. No. 5,085,698). However, such improvements are still desired to the method as inhibiting coagulation between particles due to mutual interaction, dispersing them in a solvent for a long time, tint, coloring and fixability.

### DISCLOSURE OF THE INVENTION

The present invention is designed with respect to such problems in conventional methods, and is directed at providing an ink composition having an adequate dispersibility of a coloring material, and providing a production method therefor.

In addition, the present invention directs at providing the ink composition for an ink-jet device, which has adequate fixability and further adequate tint and coloring of a printed image, and providing a production method therefor.

In addition, the present invention directs at providing an image-forming method with the use of the above described ink composition, and an image-forming device used for it.

Specifically, the first of the present invention is an ink composition characterized in that the particles of a solid coloring material are enclosed in a micelle formed of block polymer.

The above described ink composition is preferably a dispersion ink composition.

The above described solid coloring material in an amount of preferably 90 wt % or more, more preferably 98 wt % or more, and further preferably 98 wt % or more with respect to the total solid coloring material is enclosed by the block polymer.

The average particle size of the above described particles is preferably 200 nm or smaller.

In addition, an ink composition according to the present invention is preferably an ink composition for an ink-jet device.

The second of the present invention is a method for producing an ink composition, characterized by a step of forming particles by insolubilizing a coloring material and a block polymer in a state of both being dissolved in a solution.

In addition, another aspect of the present invention is a method for producing an ink composition, characterized by a step of forming particles by adding and dispersing a coloring material dissolved in a solution into a solvent dispersion having block polymer forming a micelle.

The third invention is an image-forming method for recording an image by giving an ink onto a medium to be recorded, characterized in that the ink is the above described ink composition.

The fourth invention is an image-forming device used for the above described image-forming method.

### BRIEF DESCRIPTION OF THE DRAWINGS

FIG. 1 is a view showing a schematic mechanism of an image-recording device according to the present invention.

### BEST MODE FOR CARRYING OUT THE INVENTION

Below, the present invention will be described in detail.

The first of the present invention is a dispersion ink composition characterized in that the dispersion ink contains the particles of a solid coloring material substantially enclosed by block polymer, and a solvent. In the present invention, the solid coloring material is used in a characteristic manner.

Here, enclosure refers to a state of being wrapped inside block polymer. It refers to, for instance, the state in which a coloring material exists in a hydrophobic core of a micelle formed of block polymer in water.

The solid coloring material refers to a coloring material in a crystal state or a vitrified state, which, for instance, includes a solidified material of a pigment or a dye, a crystallized material and a vitrified coloring material. The examples are shown below.

A pigment mainly refers to a coloring agent of a powdery particulate, which is insoluble in water and an organic solvent, and may be any of an organic pigment and an inorganic pigment. As a pigment used for ink, a black pigment and primary color pigments of cyan, magenta, yellow, red, green and blue can be preferably used. In addition, a color pigment other than the above described pigments, an achromatic or light-colored pigment, or a pigment with a metallic luster may be used. In addition, new synthetic pigment may be used for the present invention.

Furthermore, the pigment to be used has desirably the average primary particle size of 50 nm, can employ commercially available pigment, and can employ a pigment which has been refined (mechanically crushed by milling, for instance) and classified, as well.

Below, commercially available pigments of black, cyan, magenta and yellow are exemplified.

Examples of black pigments include, but not limited to, Raven 1060, Raven 1080, Raven 1170, Raven 1200, Raven 1250, Raven 1255, Raven 1500, Raven 2000, Raven 3500, Raven 5250, Raven 5750, Raven 7000, Raven 5000 ULTRA II, Raven 1190 ULTRA II (all of the above, from Columbian Carbon Company), Black Pearls L, MOGUL-L, Regal 400R, Regal 660R, Regal 330R, Monarch 800, Monarch 880, Monarch 900, Monarch 1000, Monarch 1300, Monarch 1400 (all of the above, from Cabot Corporation), Color Black FW1, Color Black FW2, Color Black FW200, Color Black 18, Color Black S160, Color Black S170, Special Black 4, Special Black 4A, Special Black 6, Printex 35, Printex U, Printex 140U, Printex V, Printex 140V (all of the above, from Degussa AG), No. 25, No. 33, No. 40, No. 47, No. 52, No. 900, No. 2300, MCF-88, MA600, MA7, MA8, and MA100 (all of the above, from Mitsubishi Chemical Corporation).

Examples of cyan pigments include, but not limited to, C. I. Pigment Blue-1, C. I. Pigment Blue-2, C. I. Pigment Blue-3, C. I. Pigment Blue-15, C. I. Pigment Blue-15:2, C. I. Pigment Blue-15:3, C. I. Pigment Blue-15:4, C. I. Pigment Blue-16, C. I. Pigment Blue-22, and C. I. Pigment Blue-60.

Examples of magenta pigments include, but not limited to, C. I. Pigment Red-5, C. I. Pigment Red-7, C. I. Pigment Red-12, C. I. Pigment Red-48, C. I. Pigment Red-48:1, C. I. Pigment Red-57, C. I. Pigment Red-112, C. I. Pigment Red-122, C. I. Pigment Red-123, C. I. Pigment Red-146, C. I. Pigment Red-168, C. I. Pigment Red-184, C. I. Pigment Red-202, and C. I. Pigment Red-207.

Examples of yellow pigments include, but not limited to, C. I. Pigment Yellow-12, C. I. Pigment Yellow-13, C. I. Pigment Yellow-14, C. I. Pigment Yellow-16, C. I. Pigment Yellow-17, C. I. Pigment Yellow-74, C. I. Pigment Yellow-83, C. I. Pigment Yellow-93, C. I. Pigment Yellow-95, C. I. Pigment Yellow-97, C. I. Pigment Yellow-98, C. I. Pigment Yellow-114, C. I. Pigment Yellow-128, C. I. Pigment Yellow-129, C. I. Pigment Yellow-151, and C. I. Pigment Yellow-154.

The content of the pigment used for an ink composition according to the present invention preferably is 0.1 to 50 wt % with respect to the weight of the ink composition. The pigment in an amount less than 0.1 wt % does not provide an adequate image density, and the pigment in an amount exceeding 50 wt % may aggravate the fixability of an image. The further preferable amount of the pigment is in a range between 0.5 to 30 wt %.

In addition, a dye applicable to an ink composition according to the present invention may be a well-known one or a new one. For instance, as will be described below, a water-soluble dye such as a direct dye, an acid dye, a basic dye, a reactive dye and a food dye, and a water-insoluble dye such as a lipophilic (oil-soluble) dye and a disperse dye, can be used, though in a solidified state. In this respect, for instance, the oil-soluble dye is preferably used. The examples include C. I. Solvent Blue-33, -38, -42, -45, -53, -65, -67, -70, -104, -114, -115, and -135;

C. I. Solvent Red-25, -31, -86, -92, -97, -118, -132, -160, -186, -187, and -219; and

C. I. Solvent Yellow-1, -49, -62, -74, -79, -82, -83, -89, -90, -120, -121, -151, -153, and -154.

Water-soluble dyes are also usable. The examples include direct dyes such as C. I. Direct Black-17, -19, -22, -32, -38, -51, -62, -71, -108, -146, and -154;

C. I. Direct Yellow-12, -24, -26, -44, -86, -87, -98, -100, -130, and -142;

C. I. Direct Red-1, -4, -13, -17, -23, -28, -31, -62, -79, -81, -83, -89, -227, -240, -242, and -243;

C. I. Direct Blue-6, -22, -25, -71, -78, -86, -90, -106, and -199;

C. I. Direct Orange-34, -39, -44, -46, and -60;

C. I. Direct Violet-47 and -48;

C. I. Direct Brown-109; and

C. I. Direct Green-59;

acid dyes such as C. I. Acid Black-2, -7, -24, -26, -31, -52, -63, -112, -118, -168, -172, and -208;

C. I. Acid Yellow-11, -17, -23, -25, -29, -42, -49, -61, -71;

C. I. Acid Red-1, -6, -8, -32, -37, -51, -52, -80, -85, -87, -92, -94, -115, -180, -254, -256, -289, -315, and -317;

C. I. Acid Blue-9, -22, -40, -59, -93, -102, -104, -113, -117, -120, -167, -229, -234, and -254;

C. I. Acid Orange-7 and -19;

C. I. Acid Violet-49;

reactive dyes such as C. I. Reactive Black-1, -5, -8, -13, -14, -23, -31, -34, and -39;

C. I. Reactive Yellow-2, -3, -13, -15, -17, -18, -23, -24, -37, -42, -57, -58, -64, -75,. -76, -77, -79, -81, -84, -85, -87, -88, -91, -92, -93, -95, -102, -111, -115, -116, -130, -131, -132, -133, -135, -137, -139, -140, -142, -143, -144, -145, -146, -147, -148, -151, -162, and -163;

C. I. Reactive Red-3, -13, -16, -21, -22, -23, -24, -29, -31, -33, -35, -45, -49, -55, -63, -85, -106, -109, -111, -112, -113, -114, -118, -126, -128, -130, -131, -141, -151, -170, -171, -174, -176, -177, -183, -184, -186, -187, -188, -190, -193, -194, -195, -196, -200, -201, -202, -204, -206, -218, and -221;

C. I. Reactive Blue-2, -3, -5, -8, -10, -13, -14, -15, -18, -19, -21, -25, -27, -28, -38, -39, -40, -41, -49, -52, -63, -71, -72, -74, -75, -77, -78, -79, -89, -100, -101, -104, -105, -119, -122, -147, -158, -160, -162, -166, -169, -170, -171, -172, -173, -174, -176, -179, -184, -190, -191, -194, -195, -198, -204, -211, -216, and -217;

C. I. Reactive Orange-5, -7, -11, -12, -13, -15, -16, -35, -45, -46, -56, -62, -70, -72, -74, -82, -84, -87, -91, -92, -93, -95, -97, and -99;

C. I. Reactive Violet-1, -4, -5, -6, -22, -24, -33, -36, and -38;

C. I. Reactive Green-5, -8, -12, -15, -19, and -23; and

C. I. Reactive Brown-2, -7, -8, -9, -11, -16, -17, -18, -21, -24, -26, -31, -32, and -33; and

C. I. Basic Black-2;

C. I. Basic Red-1, -2, -9, -12, -13, -14, and -27;

C. I. Basic Blue-1, -3, -5, -7, -9, -24, -25, -26, -28, and -29;

C. I. Basic Violet-7, -14, and -27; and

C. I. Food Black-1 and -2.

The examples of the above described coloring material are particularly preferable for an ink composition according to the present invention, but the coloring material used in an ink composition according to the present invention is not particularly limited to the above described coloring material.

The content of a solidified or crystallized dye used in an ink composition according to the present invention is preferably 0.1 to 50 wt % to the weight of the ink composition. The dye in an amount less than 0.1 wt % does not provide an adequate image density, and the dye in an amount exceeding 50 wt % may aggravate the fixability of an image. The further preferable amount of the dye is in a range between 0.5 to 30 wt %.

In the present invention, pigment and dye may be used together.

The vitrified coloring material includes such a high polymer containing a coloring material and a high polymer complex of a coloring material as having a high glass transition temperature. The preferred range of the content for an ink composition is equivalent to that of the above described pigment and dye.

In the next place, the block polymer of the component which is further characteristically used in the present invention, will be described.

The specific examples of the block polymer usable for the present invention include conventionally known block polymers such as acrylic and methacrylic block polymers, addition or condensation block polymers of polystyrene and another substance and block polymers having a block of polyoxyethylene or polyoxyalkylene. In the present invention, a block polymer containing a polyvinyl ether structure is preferably used. In addition, in the present invention, the block polymer may be a graft polymer containing a polyvinyl ether structure. The segment of the block polymer may be a copolymerized segment of which the form of the copolymerization is not limited, and for instance, may be a random segment or a graduation segment.

A block polymer containing a polyvinyl ether structure preferably used in the present invention will be now described. Many methods for synthesizing a polymer containing a polyvinyl ether structure have been reported (Japanese Patent Laid-Open No. H11-080221), but a representative one is a method by cation living polymerization reported by Aoshima et al. (Japanese Patent Laid-Open No. H11-322942 and Japanese Patent Laid-Open No. H11-322866). The method for synthesizing polymers by cation living polymerization can synthesize various polymers such as a homopolymer or a copolymer consisting of two or more monomers, further a block polymer, a graft polymer and a graduation polymer, so as to precisely acquire equal length (molecular weight). In addition, the polyvinyl ether can have various functional groups introduced into the side chain. The cationic polymerization can be otherwise carried out in a HI/I₂ or HCl/SnCl₄ system.

In addition, the structure of a block polymer containing a polyvinyl ether structure may be a copolymer comprising a vinyl ether and other polymers.

In the present invention, the block polymer more preferably has a block form such as AB, ABA and ABD. A, B and D show different block segments from each other.

The block polymer with the above described polyvinyl ether structure has preferably such a specific repeating unit structure of the polyvinyl ether structure as to be expressed below general formula (1): 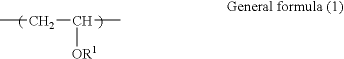
wherein, R¹ is selected among a straight-chain, a branched or cyclic alkyl group having 1 to 18 carbon number, —(CH(R²)—CH(R³)—O)_{L}—R⁴ and —(CH₂)ₘ—(O)ₙ—R⁴; L and m are independently selected among integers of 1 to 12; n is 0 or 1; R² and R³ are independently a hydrogen atom or CH₃; R⁴ is a hydrogen atom, a straight, branched or cyclic alkyl group of having 1 to 6 carbon numbers, Ph, Pyr, Ph-Ph, Ph-Pyr, —CHO, —CH₂CHO, —CO—CH═CH₂, —CO—C(CH₃)═CH₂ or —CH₂COOR⁵, and if R⁴ is the other substance than a hydrogen atom, the hydrogen atom on a carbon atom can be replaced by a straight-chain or branched-chain alkyl group of having 1 to 4 carbon numbers, F, Cl or Br, and a carbon atom in an aromatic ring by a nitrogen atom, respectively; R⁵ is a hydrogen atom or an alkyl group having 1 to 5 carbon numbers.

In the present invention, -Ph represents a phenyl group, -Pyr a pyridyl group, -Ph-Ph a biphenyl group, and -Ph-Pyr a pyridyl phenyl group. The pyridyl group, the pyridyl phenyl group and the biphenyl group may be any of isomers of taking a possible position.

In the present invention, an amphiphilic block polymer is preferably employed. For instance, the amphiphilic block polymer can be obtained by selecting a hydrophobic block segment and a hydrophilic block segment from the repeating unit structure of the above described general formula (1), and synthesizing them.

In the next place, the structures of a vinyl ether monomer are written as the examples of the repeating unit structure for the polyvinyl ether structure of a block polymer, but polyvinyl ether structures used in the present invention are not limited to these. 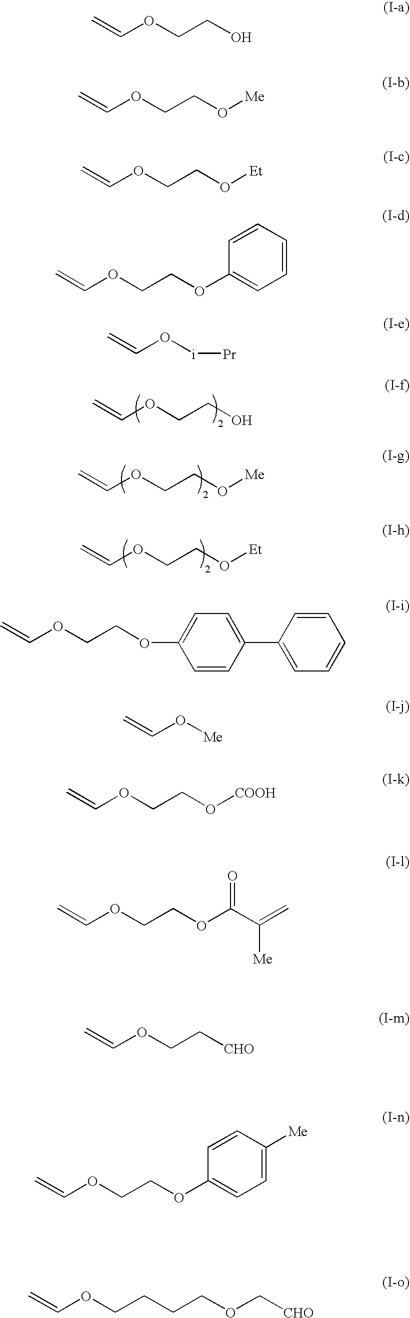
Wherein Me represents a methyl group, Et an ethyl group and i-Pr an isopropyl group.

The structures of a polyvinyl ether consisting of these vinyl ether monomers are exemplified below, but a polymer used in the present invention is not limited to them.

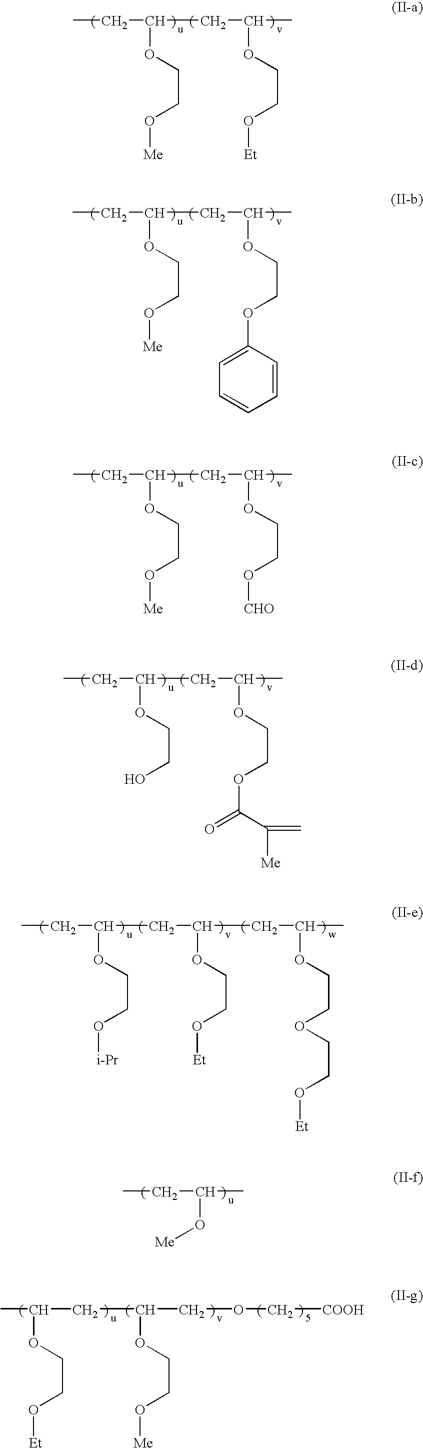

In the above described polyvinyl ether, the u, v and w of a repeating unit number are independently preferably 1 or more and 10,000 or less, and more preferably the total (u+v+w) is 10 or more and 20,000 or less.

The molecular weight distribution of the block polymer used in the present invention, which is equal to Mw (weight average molecular weight)/Mn (number average molecular weight), is 2.0 or less, preferably 1.6 or less, further preferably 1.3 or less, and particularly preferably 1.2 or less. The number average molecular weight Mn of a block polymer used in the present invention is preferably 1,000 to 300,000, further preferably 5,000 or more but 100,000 or less. The number average molecular weight of a hydrophobic segment is preferably 5,000 or more but 100,000 or less. The block polymer having the number average molecular weight Mn of less than 1000 or more than 300,000 may not adequately disperse a material which plays a predetermined function in a solvent.

In addition, in order to acquire improved dispersion stability and inclusion capability, the block polymer preferably has more flexible molecular mobility, because such a block polymer is easily physically entangled with the surface of the solid coloring material of a functional material. In addition, as will be described in detail below, the block polymer preferably has the flexible molecular mobility also in the respect of easily forming a coating layer on a medium to be recorded. For this purpose, the glass transition temperature Tg of a main chain of a block polymer is preferably 20° C. or lower, more preferably 0° C. or lower and further preferably −20° C. or lower. In this respect as well, a polymer having a polyvinyl ether structure is preferably used because of having a lower glass transition point and flexible characteristics.

The content of the above described block polymer in an ink composition according to the present invention is 0.1 to 50 wt %, and preferably 0.5 to 20 wt %. When the content of the block polymer is less than 0.1 wt %, the block polymer may not be able to adequately disperse or include the coloring material contained in the ink composition according to the present invention, and when the content exceeds 50 wt %, the ink composition may have too high viscosity.

A solvent contained in an ink composition according to the present invention is not particularly limited, but means a medium capable of dissolving, suspending, and dispersing a component contained in the ink. The solvent used in the present invention includes an organic solvent such as various aliphatic hydrocarbons with a straight chain, a branched chain and a cyclic chain, aromatic hydrocarbons and heteroaromatic hydrocarbons; an aqueous solvent; and water. In an ink composition according to the present invention, particularly water and an aqueous solvent can be preferably used. The examples of the aqueous solvent include polyvalent alcohols such as ethylene glycol, diethylene glycol, triethylene glycol, polyethylene glycol, propylene glycol, polypropylene glycol and glycerin; polyalcoholic ethers such as ethylene glycol monomethyl ether, ethylene glycol monoethyl ether, ethylene glycol monobutyl ether, diethylene glycol monoethyl ether and diethylene glycol monobutyl ether; and a nitrogen-containing solvent such as N-methyl-2-pyrrolidone, substituted pyrrolidone and triethanolamine. In addition, for an ink used for the purpose of quick drying on paper, monovalent alcohols such as methanol, ethanol and isopropyl alcohol can be used. The usable content of a solvent, particularly of the above described water or aqueous solvent, in an ink composition according to the present invention, is preferably in a range of 20 to 99 wt % and further preferably of 30 to 95 wt % with respect to the total weight of an aqueous dispersion.

An ink composition according to the present invention is allowed to contain other components than the above. An ink composition according to the present invention is characterized in that a solid coloring material is enclosed by a block polymer. When the solid coloring material is enclosed by the block polymer, the coloring material can inhibit the decomposition of itself, and improve its coloring properties if having a small particle size. The coloring material preferably has a specific particle size of 200 nm or smaller by average.

The solid coloring material can be enclosed by the block polymer by adding a solution containing a coloring material dissolved in a water-insoluble organic solvent, to a micelle, for instance, formed of block polymer in water, and then distillation-removing the organic solvent. The solid coloring material enclosed by the block polymer can be formed by another method of forming the included state, through phase-inverting a solution in a state of both a polymer and a coloring material being dissolved in an organic solvent into a state of being dispersed in a water-based solvent, and distillation-removing the remaining organic solvent. Furthermore, it can be formed by adding a liquid having a pigment dispersed in a water-insoluble organic solvent, to a micelle, for instance, formed of block polymer in water. It can be formed by still another method of forming an enclosed state by phase-inverting a dispersion in a state of a block polymer being dissolved and a coloring material being dispersed in an organic solvent, into a state of being dispersed in a water-based solvent. The enclosed state can be confirmed with various instrumental analysis methods such as an electron microscope and X-ray diffraction. When the coloring material is included in a micelle, the enclosed state can be confirmed by separating a polymer and a coloring material independently from a solvent in a micelle-decomposing condition. As discussed above, the block polymer preferably forms a micelle state, and for that purpose, the block polymer used in the present invention is preferably amphiphilic.

The amount of a solid coloring material enclosed in particles is preferably 90 wt % or more, more preferably 95 wt % or more and further preferably 98 wt % or more. The quantitative ratio as well can be determined through various electron microscopes, instrumental analysis such as X-ray diffraction, and analysis for the coloring concentration of a coloring material.

An ink according to the present invention is characterized in that the pigment is enclosed by block polymer. Because the pigment is enclosed by block polymer, the coloring material can inhibit the decomposition of itself. The smaller is the particle size, the more improved are the coloring properties. The dispersion stability, coloring strength and color vividness of a coloring material-dispersed ink are greatly affected by the particle size of the dispersed particle and the uniformity of the particle size. Specifically, the particles with large particle sizes dispersed in a solvent cause coagulation between the particles and cannot be stably dispersed. In addition, because a particle size and coloring strength are in inverse proportion (Annalen der Physik, vol. 25, p. 377, 1908), a large particle size reduces the coloring strength. The average primary particle size of the pigment is preferably 50 nm or smaller, further preferably 40 nm or smaller, more preferably 30 nm or smaller, and furthermore, preferably 20 nm or smaller. The average primary particle size of the pigment can be measured, for instance, with a scanning or transmission electron microscope. In addition, micelle particles have preferably the average particle size of 200 nm or smaller. An ink containing pigment enclosed by block polymer is produced by the steps of adding the pigment to a solution in the state of the block polymer being dissolved in a solvent, dispersing it therein, and insolubilizing the above described block polymer, or adding the pigment to a solvent dispersion containing the block polymer forming a micelle and dispersing it therein. The enclosed state can be confirmed with various instrumental analysis methods such as an electron microscope and X-ray diffraction. When the coloring material is included in a micelle, the enclosed state can be confirmed by separating a polymer and a coloring material independently from a. solvent in a micelle-decomposing condition. As discussed above, the block polymer preferably forms a micelle state, and for that purpose, the block polymer used in the present invention is preferably amphiphilic.

A preferred embodiment of an ink composition according to the present invention is an ink composition for an ink-jet device, and a further preferable embodiment is an ink of coping with an on-demand type ink-jet device. Examples of the on-demand type ink-jet device include a thermal type and a piezo type. In any type, very low viscosity is required for the ink, which is typically 5 cps or lower. The ink composition of a preferred embodiment according to the present invention disperses a solid coloring material enclosed by amphiphilic block polymer, so that it can realize such a dispersed state as to obtain low viscosity. In addition, the ink composition having a decreased variance of the molecular weight of a block polymer is preferable in respect of viscosity.

In addition, the above described coloring material-enclosing block polymer particle has an average particle size of preferably 200 nm or smaller. When the block polymer particle has the average particle size of 200 nm or smaller, it can improve coloring properties and inhibit scattering of visible light, and consequently can realize adequate color expression. The average particle size is further preferably 150 nm or smaller, and more preferably 100 nm or smaller.

The particle size can be measured, for instance, with a dynamic light-scattering method. When the ink composition is used for an ink-jet device, the block polymer particle had better have a narrower particle size distribution, so that a dispersion index (μ/G2) which indicates the particle size distribution is 0.2 or less, preferably 0.1 or less, further preferably 0.05 or less, and further preferably 0.01 or less. The measure for the uniformity of the particle size, or equivalently, the dispersion index μ/G2 (μ: secondary coefficient of cumulant expansion, and G: attenuation coefficient) is based on a literature written by Gulari and others (The Journal of Chemical Physics, vol. 70, p. 3,965, 1979). This value is also determined by a dynamic light-scattering method. An apparatus for measuring a particle size with the dynamic light-scattering method includes an apparatus such as DLS7000 made by Otsuka Electronics Co., Ltd. In addition, the particle size can be measured through electron microscope observation.

In addition, a particle size and particle size distribution can be also measured through observation by a transmission electron microscope, a scanning electron microscope and the like.

Next, the second of the present invention is a method for producing the above described ink composition, by insolubilizing both the coloring material in the state of a solution and the above described block polymer in the state of being dissolved, and a method for producing the above described ink by adding the coloring material in the above described solution state into a solvent dispersion liquid having a block polymer forming a micelle, and dispersing it therein. The ink which contains a solid coloring material-enclosing block polymer, can be produced in the above described method.

The third of the present invention is a method for forming an image by an ink-jet method with the use of the above described ink. In the next place, an image-forming method according to the present invention will be described.

[Image-Forming Method]

An ink according to the present invention can be used in image-forming devices with the use of various ink-jet methods. An image can be formed by the image-forming method with the use of the device. The ink-jet method to be used may be a well-known method such as a piezo ink-jet type using a piezoelectric element, or a thermal ink-jet type of exerting thermal energy on the ink to make it foam and record; and may be either a continuous type or an on-demand type. In addition, an ink composition according to the present invention can be used in a recording system of printing the ink on an intermediate transcript and transferring it to a final medium to be recorded such as paper.

The fourth of the present invention is a device for recording an image through the above described image-forming method.

[Image-Recording Device]

An ink-jet recording device using an ink composition for the ink-jet method according to the present invention includes an ink-jet recording device of a piezo ink-jet type using a piezoelectric element, and of a thermal ink-jet type of exerting thermal energy on the ink to make it foam and record.

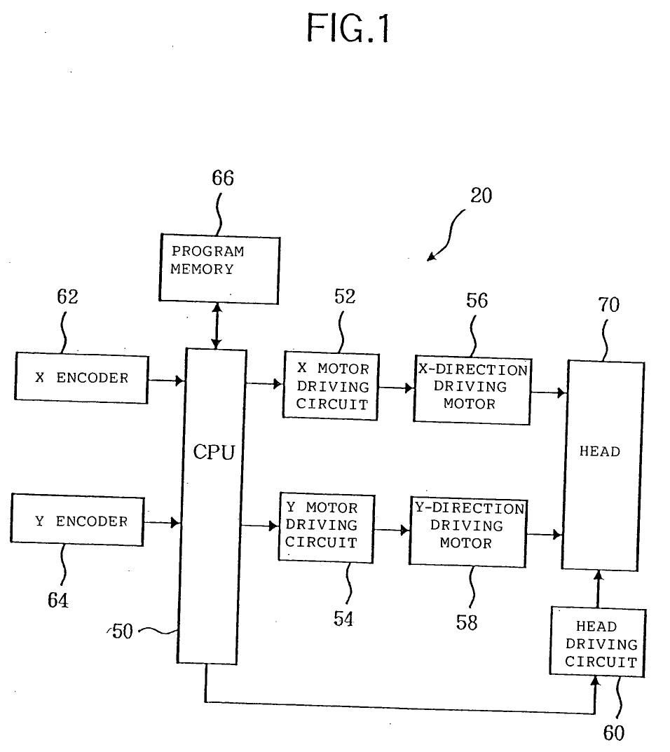

FIG. 1 shows a schematic functional diagram of an ink-jet recording device. Reference numeral 50 denotes a central processing unit (CPU) of an ink-jet recording device. A program for controlling CPU 50 may be memorized in a program memory 66, or as a so-called firm-ware, may be stored in a memory such as EEPROM (not shown). An ink-jet recording device receives data to be recorded from a recording-data-creating means (not shown, but a computer or the like) and stores them in the program memory 66. The recording data may be an image to be recorded, textual information as they are, compressed information thereof, or encoded information. In the case of processing the compressed or encoded information, the recording device can obtain the image to be recorded or the textual information by making CPU 50 carry out extension or expansion. If an X encoder 62 (for instance, in an X-direction or a main scanning direction) and a Y encoder 64 (for instance, in a Y-direction or a sub-scanning direction) are installed, they can inform the relative position of a head with respect to a medium to be recorded, to CPU 50.

The CPU 50, on the basis of the information from the program memory 66, the X encoder 62 and the Y encoder 64, transmits signals for recording an image to an X motor-driving circuit 52, a Y motor-driving circuit 54 and a head-driving circuit 60. The X motor-driving circuit 52 and the Y motor-driving circuit 54 respectively drive the X-direction driving motor 56 and the Y-direction driving motor 58 to move the head 70 relatively to the medium to be recorded into the recording position. The head drive circuit 60 transmits signals for making the head 70 discharge various ink compositions (Y, M, C, K) or stimulus-giving materials which work as stimulus to the head 70 when it has moved to the recording position, and carries out recording. The head 70 may discharge a monochromatic ink composition.

Referring to examples, the present invention will be described in detail below, but the present invention is not limited to the examples.

### EXAMPLE 1

<Synthesis of Block Polymer>

Synthesis of single-end carboxylic acid block polymer consisting of 2-ethoxyethylvinylether (EOVE), 2-methoxyethylvinylether (MOVE) and HO (CH₂)₅COOH

Poly [EOVE (2-ethoxyethyl vinyl ether)-b-MOVE (methoxy ethyl vinyl ether)]—O (CH₂)₅COOH, (where b is a sign showing a block polymer), was synthesized by the steps described below.

Nitrogen was substituted for air in the glass vessel having a three way stopcock attached, and the glass vessel was heated to 250° C. in a nitrogen gas atmosphere to remove adsorbed water. The system was cooled back to a room temperature, then 12 mmol (millimole) of EOVE, 16 mmol of ethyl acetate, 0.1 mmol of 1-isobutoxy ethyl acetate and 11 ml of toluene were added to the system, and the reaction system was cooled. When the temperature in the system reached 0° C., 0.2mmol of ethyl aluminum sesquichloride (the equimolar mixture of diethyl aluminum chloride and ethyl aluminum dichloride) was added to start the polymerization. The molecular weight was monitored over time with the use of a molecular-sieve column chromatography (GPC), to confirm the completion of the polymerization of a component A (EOVE).

Subsequently, 12 mmol of a component B (MOVE) was added to polymerize it with the component A. The completion of the polymerization of the component B was confirmed by the monitoring with GPC, and then 30 mmol of HO (CH₂)₅COOEt was added to stop the polymerization. A reacted mixture solution was diluted with dichloromethane, and the product was washed with 0.6 M hydrochloric acid three times and subsequently with distilled water three times. The obtained organic phase was concentrated to dryness with an evaporator to obtain a block polymer of poly [EOVE-b-MOVE]—O (CH₂)₅COOEt.

The synthesized compound was identified by NMR and GPC. Particularly, an end portion thereof was identified by observing the end portion in a spectrum of the polymer with a DOSY method of NMR. Mn was 2.1×10⁴, and Mw/Mn was 1.4. Mn is number average molecular weight, and Mw is weight average molecular weight.

The ester portion at the end of the obtained poly [EOVE-b-MOVE]—O (CH₂)₅COOEt was hydrolyzed, and the obtained product was identified by NMR as poly [EOVE-b-MOVE]—O (CH₂)₅COOH of interest.

The resulting block polymer with a carboxylic acid end in 26 parts by weight was stirred with 200 parts by weight of a sodium hydroxide solution of pH 11 at 0° C. for three days, to produce a polymer solution in the form of sodium carboxylate in which the polymer was completely dissolved. The polymer was extracted from the solution with dichloromethane and the resulting solution with the polymer extracted was dried. Then, the solvent was evaporated to isolate the polymer.

The polymer in 25 parts by weight and 10 parts by weight of Oil Blue N (made by Sigma-Aldrich Corporation), a lipophilic dye, were dissolved in 80 parts by weight of dichloromethane, the resulting solution was subsequently added dropwise into 800 parts by weight of distilled water with stirring, and 200 parts by weight of ethylene glycol was further added to it. The liquid in the above state was left in an open state for three hours at 40° C. to completely remove dichloromethane and solidify a coloring material, and thus an ink composition 1 according to the present invention was prepared.

The ink composition 1 was cooled to 0° C., the EOVE segment of a block polymer was made hydrophilic, a micelle was decomposed, and the block polymer was dissolved in water. Then, the phase of the solid coloring material was separated and the water phase was completely decolorized. From this fact, it was understood that the coloring material was completely included in the micelle of the block polymer. The ratio of concentration of the coloring material in the above described discolored water phase to that in the ink composition 1 was 0.8%, by the intensity ratio of λmax, which proved that 99% or more of the coloring material were enclosed by the block polymer.

### EXAMPLE 2

The ink composition prepared in the Example 1 was charged into the ink tank of an ink-jet printer (BJF800, made by Canon Inc.), and was printed on plain paper. When the surface layer of a recorded part was observed with an electron microscope, a layer coated with a block polymer was observed.

### COMPARATIVE EXAMPLE 1

The solution, in which the lipophilic dye used in the Example 1 was dissolved in dichloromethane, was applied on plain paper with a brush. The paper was left in an atmosphere containing 10 ppm of ozone for 30 hours. The change of optical density for the coloring material on the above described paper was measured with a portable reflection density meter (RD-19 made by Sakata Ink Co.), and was compared to that on the recorded medium used in the Example 2, to show three times higher decreasing rate than that in the Example 2.

### EXAMPLE 3

<Synthesis of Block Polymer>

Synthesis of single-end carboxylic acid block polymer consisting of 2-ethoxy ethyl vinyl ether (EOVE), 2-methoxy ethyl vinyl ether (MOVE) and HO (CH₂) ₅COOH

Poly [EOVE (2-ethoxy ethyl vinyl ether)-b-MOVE (methoxy ethyl vinyl ether)]—O (CH₂)₅COOH, (where b is a sign showing a block polymer), was synthesized via the steps described below.

Nitrogen was substituted for air in the glass vessel having a three way stopcock attached, and the glass vessel was heated to 250° C. in a nitrogen gas atmosphere to remove adsorbed water. The system was cooled back to a room temperature, then 12 mmol (millimole). of EOVE, 16 mmol of ethyl acetate, 0.1 mmol of 1-isobutoxyethylacetate and 11 ml of toluene were added to the system, and the reaction system was cooled. When the temperature in the system reached 0° C., 0.2 mmol of ethyl aluminum sesquichloride (the equimolar mixture of diethyl aluminum chloride and ethyl aluminum dichloride) was added to start the polymerization. The molecular weight was monitored in a time-division manner with the use of a molecular-sieve column chromatography (GPC), to confirm the completion of the polymerization of a component A (EOVE).

Subsequently, 12 mmol of a component B (MOVE) was added to polymerize it with the component A. The completion of the polymerization of the component B was confirmed by the monitoring with GPC, and then 30 mmol of HO (CH₂)₅COOEt was added to stop the polymerization. A reacted mixture solution was diluted with dichloromethane, and the diluted solution was washed with 0.6 M hydrochloric acid three times and subsequently with distilled water three times. The obtained organic phase was concentrated to dryness with an evaporator to obtain the block polymer of poly [EOVE-b-MOVE]—O (CH₂)₅COOEt. The synthesized compound was identified by NMR and GPC. Particularly, an end portion thereof was identified by observing the end portion in a spectrum of the polymer with a DOSY method of NMR. Mn was 2.1×10⁴, and Mw/Mn was 1.4. Mn is number average molecular weight, and Mw is weight average molecular weight.

The ester portion at the end of the obtained poly [EOVE-b-MOVE]—O (CH₂)₅COOEt was hydrolyzed, and the obtained product was identified by NMR as poly [EOVE-b-MOVE]—O (CH₂)₅COOH of interest.

The resulting block polymer with a carboxylic acid end in 26 parts by weight was mixed and stirred with 200 parts by weight of a sodium hydroxide solution of pH 11 at 0° C. for three days, to produce a polymer solution in the form of sodium carboxylate, in which the polymer was completely dissolved. The polymer was extracted from the solution with dichloromethane and the resulting solution with the polymer extracted was dried. Then, the solvent was evaporated to isolate the polymer.

The polymer in 25 parts by weight was dissolved in 80 parts by weight of dichloromethane, and then 10 parts by weight of phthalocyanine blue (made by Toyo Ink Mfg. Co., Ltd., and having the average primary particle size of 48 nm when measured with an electron microscope) was added to the solution and dispersed therein. The mixture was added dropwise into 800 parts by weight of distilled water with stirring, and 200 parts by weight of ethylene glycol was further added to it. The liquid was left in an open state for three hours at 40° C. to completely remove dichloromethane, and thus an ink composition 2 according to the present invention was prepared. When the particle size of the dispersion ink was measured with dynamic light scattering, an average micelle size was 140 nm, and the dispersion index was 0.20. The ink was cryotransferred into and observed with an EF-TEM, and as a result, spherical micelles (with the average size of 130 nm) were observed. Elemental analysis of the sample EELS revealed that the pigment was included in the block polymer micelle. The ink was cooled to 0° C., the EOVE segment of a block polymer was made hydrophilic, the micelle was decomposed, and the block polymer was dissolved in water. Then, the phase of the pigment was separated and the water phase was completely decolorized. From this fact, it was understood that the coloring material was completely included in the micelle of the block polymer. The ratio of concentration of the coloring material in the above described discolored water phase to that in the dispersion ink was 0.8%, by the intensity ratio of λmax, which proved that 99% or more of the coloring material were enclosed by the block polymer.

### EXAMPLE 4

The ink prepared in the Example 3 was charged into the ink tank of BJF800 made by Canon Inc., and was printed on plain paper. When the surface layer of a recorded part was observed with an electron microscope, a layer coated with a block polymer was observed.

### EXAMPLE 5

By using the polymer used in the Example 3 and a pigment LIONOGEN YELLOW 1010 (which has the primary particle size of 21 nm when measured electron-microscopically) made by Toyo Ink Mfg. Co., Ltd., an ink including a coloring material was prepared similarly to the Example 3. When the particle size of the dispersion ink was measured with dynamic light scattering, an average micelle size was 98 nm, and the dispersion index was 0.09. Similarly to the Example 4, the ink was charged into the ink tank of BJF800 made by Canon Inc., and was clearly printed on plain paper.

### COMPARATIVE EXAMPLE 2

The solution, in which the pigment used in the Example 3 was dispersed in dichloromethane, was cryotransferred into and observed with an EF-TEM similarly to the Example 4, and as a result, needle crystals were observed, but spherical micelles observed in the Example 1 were not observed. As a result, it was assumed that the pigment was not coated but was in a crystal state.

The ink was applied on plain paper with a brush. The paper was left in an atmosphere containing 10 ppm of ozone for 30 hours. The change of optical density for the coloring material on the above described paper was measured with RD-19 made by Sakata Ink Co., and was compared to that on the recorded medium used in the Example 2, to show two times higher decreasing rate than that in the Example 2.

The results of the examples and the comparative examples described above can differ in some degree according to the difference of the specification and the maker of measuring instruments.

### INDUSTRIAL APPLICABILITY

As described above, the present invention can provide an ink composition which contains a solid coloring material, a block polymer and a solvent, and has the adequate dispersibility of the coloring material.

In addition, the present invention can provide an ink composition for an ink-jet device, which has adequate fixability and further adequate tint and coloring of a printed image.

In addition, the present invention can easily provide a method for producing an ink composition superior in the dispersibility of the above described coloring material.

In addition, the present invention can provide an image-forming method with the use of the above described ink composition, and an image-forming device used for it.

1. A composition characterized in that the particles of a solid coloring material are enclosed in a micelle formed of a block polymer.

2. The composition according to claim 1, wherein 90 wt % or more of the solid coloring material are enclosed by the block polymer.

3. The composition according to claim 1, wherein the average particle size of the particles is 200 nm or less.

4. The composition according to claim 3, wherein the particle size distribution has a dispersion index μ/G2 of 0.2 or less.

5. The composition according to claim 1, wherein the block polymer contains a repeating unit structure of a polyvinyl ether.

6. A method for producing a composition having the particles of a solid coloring material enclosed in a micelle formed of a block polymer, characterized by a step of forming particles by insolubilizing the coloring material and the block polymer in a state of both being dissolved or uniformly dispersed.

7. A method for producing a composition having the particles of a solid coloring material enclosed in a micelle formed of a block polymer, characterized by a step of forming particles by adding and dispersing a coloring material dissolved in a solution into a solvent dispersion having the block polymer forming a micelle.

8. An image-forming method for recording the image by giving an ink onto a medium to be recorded, characterized in that the ink is a composition containing the particles of a solid coloring material enclosed in a micelle formed of a block polymer.

9. An image-forming device for recording the image by giving an ink onto a medium to be recorded, characterized in that the ink is a composition containing the particles of a solid coloring material enclosed in a micelle formed of a block polymer.

10. The composition according to claim 1, characterized in that the particle of the solid coloring material is pigment.

11. The composition according to claim 10, characterized in that the average primary particle size of the pigment is 50 nm or smaller.
